(19) United States
(12) Patent Application Publication
(10) Pub. No.: US 2013/0201967 A1
(43) Pub. Date: Aug. 8, 2013

(54) Open/Closed Loop Synchronization for Radio Transmitters

(71) Applicant: Markus Nentwig, Helsinki (FI)

(72) Inventor: Markus Nentwig, Helsinki (FI)

(73) Assignee: NOKIA CORPORATION, Espoo (FI)

(21) Appl. No.: 13/639,945

(22) PCT Filed: Apr. 22, 2010
(86) PCT No.: PCT/FI10/50330

§ 371 Date: Dec. 19, 2012

(51) Int. Cl. H04W 56/00

(52) U.S. Cl. CPC H04W 56/001
USPC 370/336

(57) ABSTRACT

Methods and systems can provide accurate synchronization of two nodes even when those nodes cannot communicate directly with one another. A method, for example, can include determining a first propagation delay estimate to a first node (910). The method can also include determining a second propagation delay estimate to a second node (920). The method can further include receiving a first synchronization message from the first node (930). The method can additionally include transmitting a second synchronization message to the second node (940). The second synchronization message depends on the first synchronization message, the first propagation delay estimate, and the second propagation delay estimate.

### BACKGROUND

1. Field

Wireless devices, infrastructure, modules, and chipsets may benefit from techniques for synchronization of wireless devices. In particular, systems requiring such a precise network synchronization that propagation delays between the nodes are important may benefit from improved synchronization techniques. An example could be local area evolution (LAE) as an enhancement to the Third Generation Partnership Project (3GPP). Synchronization is a physical layer procedure. In general, embodiments of the invention may be useful to provide accurate network synchronization, even when node-to-node synchronization would not be easy.

2. Description of the Related Art

In many cellular systems, such as Long Term Evolution (LTE) of 3GPP, base stations track and compensate for the propagation delay changes and clock drifts with a closed timing adjustment loop. Additionally, in some cases a radio network controller (RNC) may compensate for propagation delay changes or clock drifts in a base station based on measurements obtained from a user equipment (UE).

However, nothing is decided based on the observations on UE motion. Instead, the validity of timing adjustment commands is based on a simple timer. Even in the example of the RNC-based compensation, the technique employed is to compare the time difference of arrival (TDOA) of reference signals from two base stations to database values, in order to adjust a time base of one of the base stations.

Thus, there is no system in which propagation delays from a third node to two other nodes are determined in order to adjust the relative transmission phases of the two other nodes.

Additionally, in, for example, certain instances of LAE, UE assistance for synchronizing two access points has been considered. In those cases, however, propagation delays have been assumed to be insignificant.

### SUMMARY

In certain embodiments, the present invention is a method. The method includes determining a first propagation delay estimate to a first node. The method also includes determining a second propagation delay estimate to a second node. The method further includes receiving a first synchronization message from the first node. The method additionally includes transmitting a second synchronization message to the second node wherein the second synchronization message depends on the first synchronization message, the first propagation delay estimate, and the second propagation delay estimate.

In another embodiment, the present invention is a method that includes estimating the accumulated movement of a radio transmitter device. The method also includes encoding the accumulated movement into a motion estimation message. Transmitting the motion estimation message to a device is also included in the method.

A non-transitory computer-readable medium encoding instructions that, when executed in hardware, perform a process can be a further embodiment of the present invention. The process can be selected from the methods discussed above.

An apparatus according to an embodiment of the present invention can include at least one memory including computer program code and at least one processor. The at least one memory and the computer program code are configured to, with the at least one processor, cause the apparatus at least to determine a first propagation delay estimate to a first node. The at least one memory and the computer program code are also configured to, with the at least one processor, cause the apparatus at least to determine a second propagation delay estimate to a second node. Further, the at least one memory and the computer program code are configured to, with the at least one processor, cause the apparatus at least to process a received first synchronization message from the first node. Additionally, the at least one memory and the computer program code are configured to, with the at least one processor, cause the apparatus at least to transmit a second synchronization message to the second node wherein the second synchronization message depends on the first synchronization message, the first propagation delay estimate, and the second propagation delay estimate.

The present invention is, in another embodiment, an apparatus that includes at least one memory including computer program code and at least one processor. The at least one memory and the computer program code are configured to, with the at least one processor, cause the apparatus at least to estimate the accumulated movement of a radio transmitter device. The at least one memory and the computer program code are also configured to, with the at least one processor, cause the apparatus at least to encode the accumulated movement into a motion estimation message. Further, the at least one memory and the computer program code are configured to, with the at least one processor, cause the apparatus at least to transmit the motion estimation message to a device.

In certain additional embodiments, the present invention is an apparatus. The apparatus includes determining means for determining a first propagation delay estimate to a first node. The apparatus also includes determining means for determining a second propagation delay estimate to a second node. The apparatus further includes receiving means for receiving a first synchronization message from the first node. The apparatus additionally includes transmitting means for transmitting a second synchronization message to the second node wherein the second synchronization message depends on the first synchronization message, the first propagation delay estimate, and the second propagation delay estimate.

In another embodiment, the present invention is an apparatus that includes estimating means for estimating the accumulated movement of a radio transmitter device. The apparatus also includes encoding means for encoding the accumulated movement into a motion estimation message. Transmitting means for transmitting the motion estimation message to a device are also included in the apparatus.

### BRIEF DESCRIPTION OF THE DRAWINGS

For proper understanding of the invention, reference should be made to the accompanying drawings, wherein:

FIG. 1 illustrates a discontinuity in an OFDM basedband stream.

FIG. 2 illustrates “sync leakage” resulting from a discontinuity.

FIG. 3 illustrates two access points (APs) synchronizing via a user equipment (UE).

FIG. 4 illustrates delay estimation of a first path.

FIG. 5 illustrates delay estimation of a second path.

FIG. 6 illustrates the transmission of a first synchronization message.

FIG. 7 illustrates the transmission of a second synchronization message.

FIG. 8 illustrates a closed loop synchronization method.

FIG. 9 illustrates a method according to certain embodiments of the present invention.

FIG. 10 illustrates another method according to certain embodiments of the present invention.

FIG. 11 illustrates a system according to certain embodiments of the present invention.

### DETAILED DESCRIPTION OF THE PREFERRED EMBODIMENT(S):

Certain embodiments of the present invention may provide accurate network synchronization even when node to node synchronization is not easy. Specifically, in certain embodiments a system is provided in which a third node records relative transmission phases of two other nodes, taking into account the effect of propagation delays to the two other nodes. A transmission phase may refer to a transmission time instant, relative to a reference transmission time instant. The reference transmission time instant may be a symbol border within a periodic frame structure, for example.

An optimized local-area (OLA) radio network may be configured to provide high-rate coverage in selected areas using a large number of cells, covered by inexpensive access points/base stations. The high data rates may be, for example, several hundred megabits per second (Mbps). For example, the OLA system may replace fixed Ethernet installations comparable to current wireless local area networks (ALAN), connecting personal computers (PCs), home entertainment devices, and other devices. Devices in such a network can share common radio resources using, for example, orthogonal frequency division multiple access (OFDMA), coordinated by a reservation protocol.

Certain embodiments of the present invention utilize mobility measurements to decide on the validity of propagation delay estimates. Additionally, certain embodiments employ a process of updating the estimates. More generally, certain embodiments of the present invention relate to a system in which a third node records the relative transmission phases of two other nodes, taking into account the effect of propagation delays to the two other nodes, as mentioned above.

In an example system according to certain embodiments of the present invention, the system may include two or more access points and one or more user equipment (UE) devices.

The access points can be connected to a wired network infrastructure. The connection to the wired network infrastructure can be by, for example, an Ethernet connection. Mobile devices, such as UE devices, can be connected via a radio link to one or more of the access points.

In such networks, the need for accurate synchronization using relayed links can lead to a need for propagation delay estimation and correction. Specifically, a need can exist for over-the-air synchronization. Access points may be required to synchronize autonomously using over-the-air signaling, due to the prohibitive cost of distributing synchronization signals in other ways such as wires or global positioning satellite (GPS) signal reception.

For example, the radio system may utilize orthogonal frequency division multiple access (OFDMA) as a multiple access technique using frequency division multiplexing (OFDM). Other multiple access techniques are also possible, and OFDMA is merely presented as an illustration. OFDMA utilizes a cyclic prefix (CP) for the separation of transmitted symbols at a receiver. Thus, it may be useful to synchronize nearby devices with an accuracy better than the cyclic prefix duration to prevent a deterioration of reception quality.

Furthermore, there may be a need for propagation delay estimation. Specifically, synchronization between radios can be achieved by exchanging synchronization messages, but synchronization messages are delayed by the propagation delay of radio waves over the wireless medium, such as air. This propagation delay can lead to inaccuracy in synchronization between or among radios.

Accurate synchronization can be achieved by estimating and correcting the propagation delay of a message. However, accurate synchronization may require relayed synchronization (sync) signaling. Specifically, two nearby access points may cover the same reception area, but have no means of establishing a link.

For example, access points (APs) may be unable to transmit and receive at the same time (half duplex). A time division duplex (TDD) frame structure may utilize one time slot for common transmission by all APs, and another time slot for common reception by all APs. Thus, there may be no possibility for one AP to transmit while another AP receives the message.

Another contingency that may exist is that APs may be located in such a way that propagation conditions do not allow a single or direct link between the APs. For example, two APs may be located under a ceiling and may be separated by other ceiling-mounted objects such as ventilation ducts, which may serve as obstacles. In another instance, the APs may cover an overlapping reception area with directional antennas that cover only the direction pointing towards the reception area, but suppress signals from other directions.

In such conditions, as well as in other conditions, two APs may utilize a user equipment (UE) in the common coverage area to relay synchronization messages.

A detailed example that follows discusses OFDM(A) is one example, although OFDM and/or OFDMA is not required for the practice of certain embodiments of the present invention.

OFDM modulation transmits a stream of symbols separated by a cyclic prefix (CP). Using OFDM for multiple access (OFDMA), a receiver processes several symbols that overlap in time but are separated in frequency. Specifically, in certain cases a receiver processes two signals from different transmitters, overlapping in time but separated in frequency, that is, two signals on different subcarriers. Transmissions are time-aligned within the duration of the cyclic prefix to prevent so-called “sync leakage” from frequencies used by one symbol into frequencies used by the other.

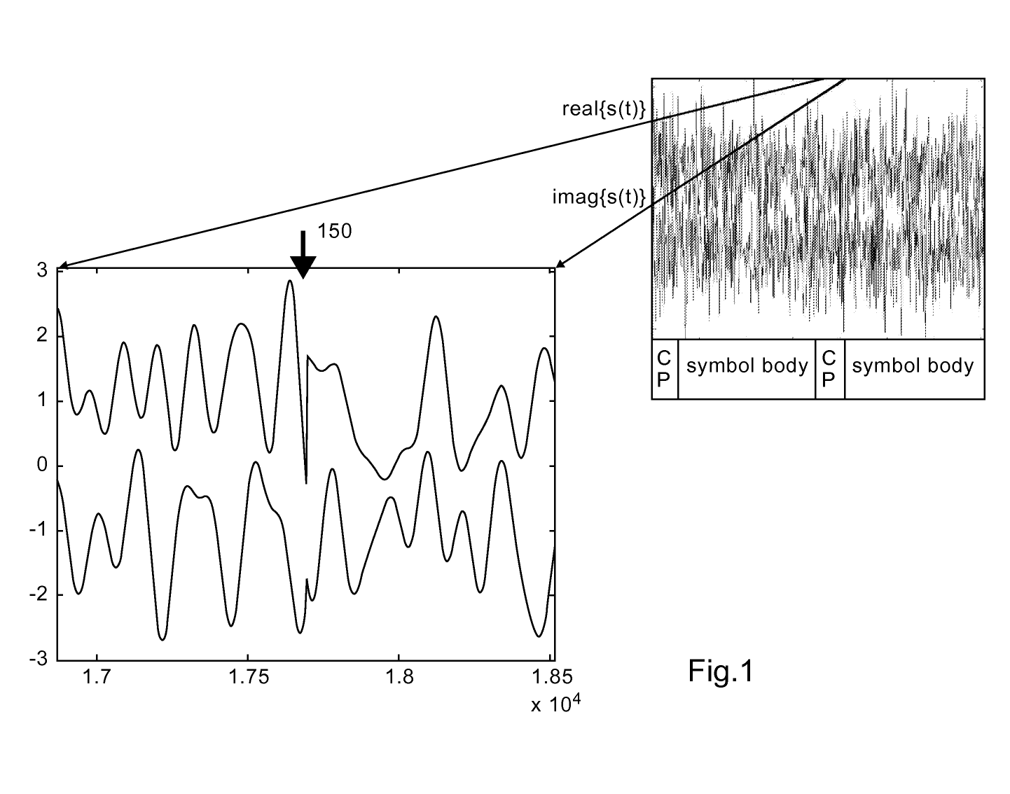

Sync leakage can be caused by a discontinuity between any two adjacent OFDM symbols in the time domain. As long as the receiver is synchronized with an interfering signal, the discontinuity falls outside of the receiver's time aperture. If synchronization is achieved, the abrupt “gap” between the symbols leaks into subcarriers not occupied by the symbol. The power spectrum of sync leakage may exhibit a shape following a sinc( ) function (sinus cardinalis or cardinal sine). FIG. 1 illustrates the discontinuity 150 in a baseband data stream between two adjacent OFDM symbols.

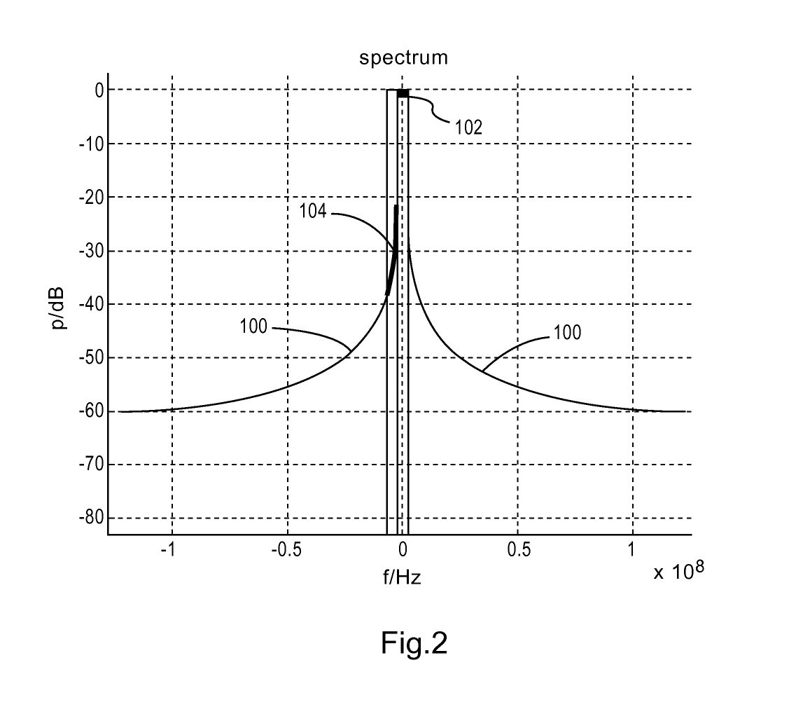

FIG. 2 shows a resulting signal spectrum of an interfering signal 102, as seen by an unsynchronized receiver. Line 100 is the complete trace of the spectrum of the signal, as seen by an unsynchronized receiver. Line segment 102 is the bandwidth corresponding to subcarriers allocated for the signal. Line segment 104 is the sync leakage generated into an adjacent channel, effecting subcarriers not allocated to the signal.

The value of estimating and correcting path delays of synchronization messages can be seen through the following discussion. For example, a CP length of 0.57 μs may be used in an optimized local-area (OLA) radio network system. The main purpose of the cyclic prefix may be to prevent intersymbol interference due to multipath propagation. Therefore, the synchronization error is smaller than the CP length in a system in which the synchronization error does not produce unwanted interference. For example, a system error of 0.1 μs might be targeted. After all, if the synchronization error is greater than the cyclic prefix length, the cyclic prefix will cease to serve as a preventive of intersymbol interference.

In a distributed synchronization algorithm, the individual measurements between two nodes may determine the overall accuracy of the system. Thus, one approach is to attempt to make the individual measurements more accurate than the targeted system accuracy. For example, a factor of four may be selected as a sufficient basis. Therefore, a measurement accuracy target can be 0.03 μs, which corresponds to a path length of 1 m. In other words, an uncertainty in a path length of one meter may result in an uncertainty in a propagation delay of 0.03 μs. This example is merely an illustration, and should not be taken as a limitation.

Interfering nodes may be physically located at a larger distance. For example, nodes may be located at 5, 10, or 20 m spacing in a corridor. The resulting delay of a synchronization message from one node to another may deteriorate the accuracy of synchronization, unless it is estimated and corrected.

As noted above, a system may involve a plurality of nodes, including multiple nodes. There's no specific limitation on the number of nodes. Nevertheless, two-node synchronization can serve as a basic building block for techniques that involve more than two nodes.

Two nodes can synchronize in an open-loop or a closed loop scheme. A closed-loop scheme can estimate and compensate the propagation delay of the messages, but it requires two-way communication.

The additional overhead for a closed-loop scheme may be undesirable, for example because of an access point's TDD operation: A node is required to suspend transmission of data, and switch to receive mode for a return message.

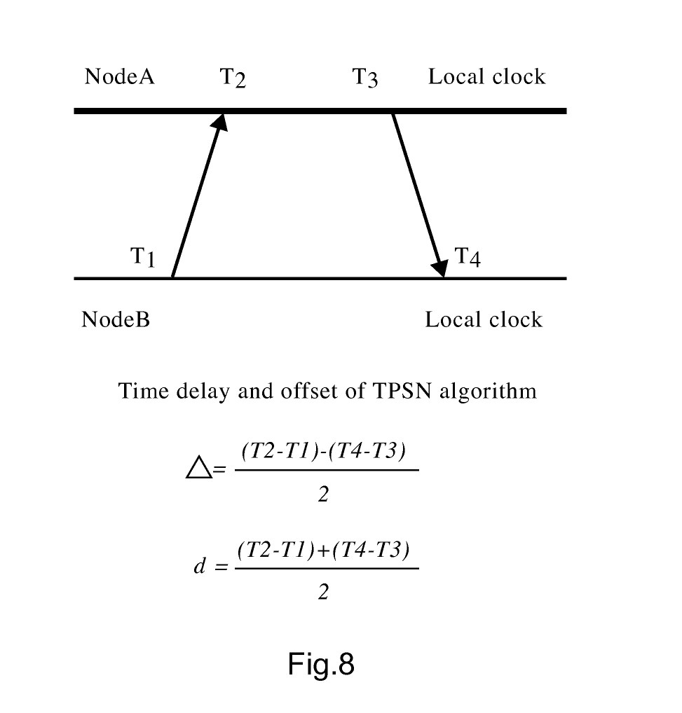

FIG. 8 illustrates a closed-loop scheme. The system in FIG. 8 employs a closed loop synchronization scheme that estimates both the time offset between nodes and the propagation delay. Open-loop calibration is used as a first step in some closed-loop techniques. In comparison, in certain embodiments of the present invention, initially closed-loop synchronization is performed, and then the propagation delay is remembered, as long as nodes do not move.

A particular challenge in an OLA network is that it may be necessary to transmit synchronization information from one access point to another via a mobile device, if no connection between APs can be established. For example, one AP would need to temporarily reverse direction of TDD channel access to receive transmissions from another AP. Propagation conditions may make this difficult or impossible, because AP antenna patterns try to optimize connections to UEs, not APs. It may happen that the radio path to the targeted AP is too lossy, while there is too much interference from several nearby APs, which otherwise cover non-overlapping cell areas.

A possible technique that will avoid such interference, obstacles, or the like is to rely on one or more mobile devices for forwarding synchronization information. The gains from accurate synchronization and thereby reduced OFDMA interference may outweigh the added signaling overhead on the mobile device, especially if the “mobile” device, such as a network interface in a personal computer (PC), is not battery powered.

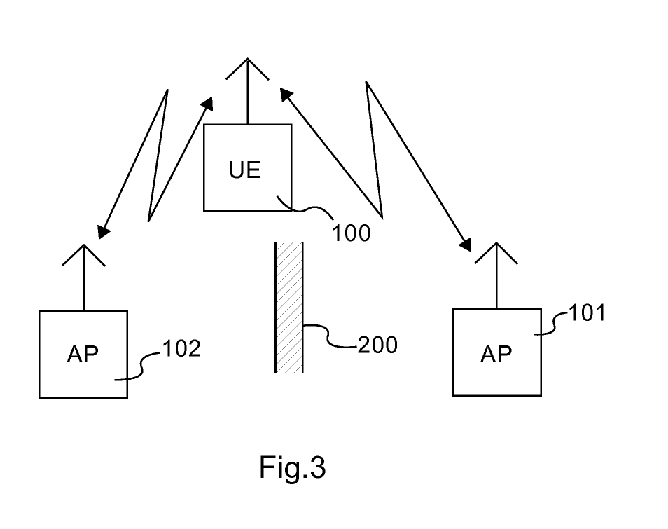

FIG. 3 illustrates an example in which two access points (APs) synchronize via a user equipment (UE). FIG. 3 shows two nodes/access points 101 and 102, synchronizing via a UE 100. An obstacle 200 is illustrated in the figure, and implies that direct communication is not possible, either because of a physical obstruction, or because of an uplink-downlink TDD switching scheme. Other reasons for obstructed direct communication are also permitted.

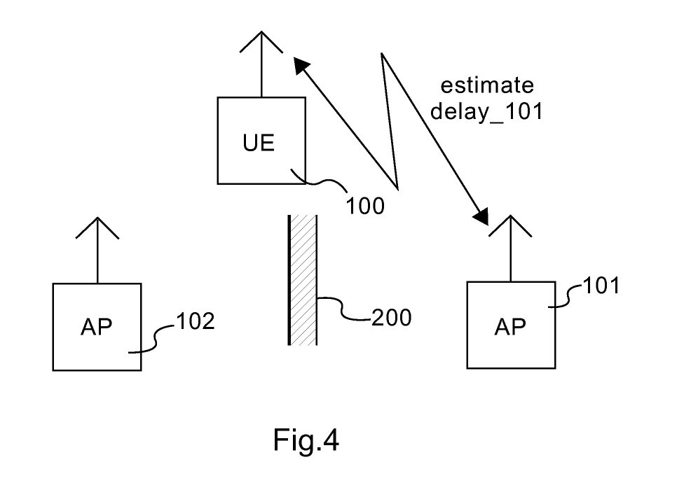

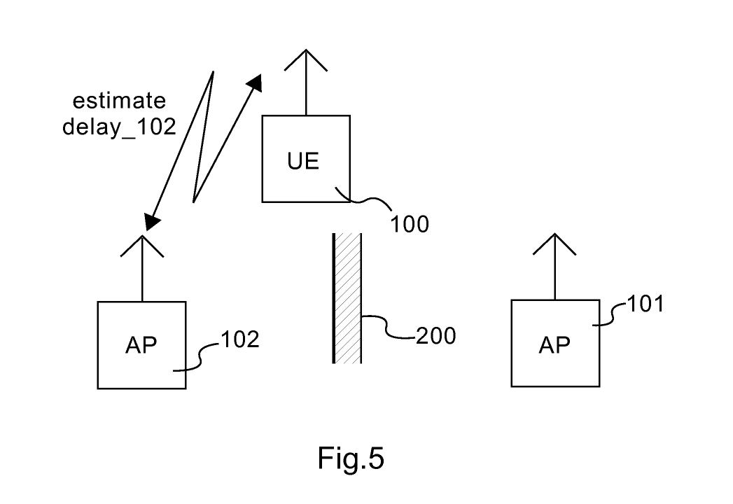

FIG. 4 shows the nodes from FIG. 3 obtaining delay estimation of a first path. UE 100 can estimate and store the propagation delay to AP 101 using two-way signaling (closed loop) as described in reference to FIG. 8. UE 100 may estimate the propagation delay to AP 101 based on timing advance commands provided by AP 101. AP 101 may use timing advance commands to instruct UE 100 to offset a transmission time instant relative to a reception time instant of a transmission from AP 101. The transmission time offset signaled in a timing advance command may be proportional to the propagation delay between UE 100 and AP 101. UE 101 may process the signaled transmission time offset using a linear equation to estimate the delay of the first path. Next, UE 100 estimates and stores the propagation delay to AP 102, as illustrated in FIG. 5.

The propagation delays may remain valid for as long as the nodes do not move too much. Movement of a node may cause an uncertainty in a stored propagation delay estimate associated with that node. For example, targeting an uncertainty in propagation delay of 0.03 μs or better, the maximum tolerable movement of a node is 1 m. The tolerable uncertainty increases with distance. For example, within one office (or in general, a small area) it may be reasonable to expect a higher synchronization accuracy than within a whole building (or in general, a larger area). Thus, the maximum tolerable movement may increase with increasing path length. For example, the maximum tolerable movement may be defined as 1 m for nodes within a 3 m radius, and increase linearly to 10 m for nodes at a distance of 300 m and beyond.

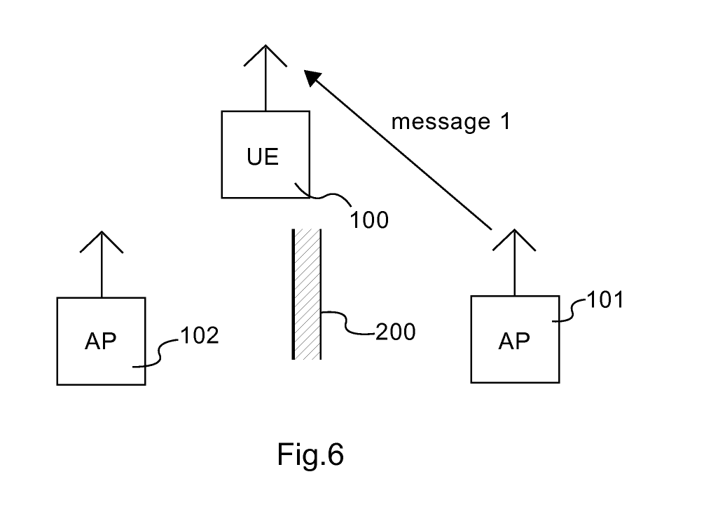

FIG. 6 illustrates a first transmission step of a synchronization process. In FIG. 6, when synchronization is desired, AP 101 requests synchronization with AP 102 from UE 100. AP 102 is known to AP 101 in this example. The way that AP 102 may know of AP 101 may be that AP 101 was previously reported as a neighbor by UE 100. Other ways of notification about AP 101 are also possible. To request synchronization, AP 101 sends a synchronization message (message 1) to UE 100 for forwarding to AP 102.

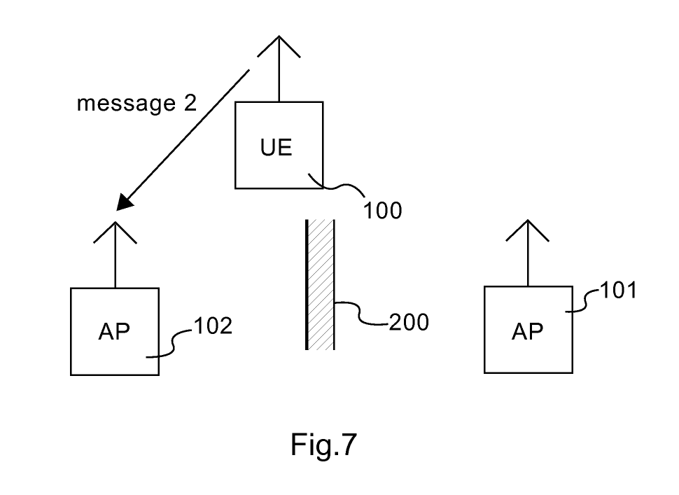

FIG. 7 illustrates a second transmission step of a synchronization process. In FIG. 7, UE 100 generates a second message (message 2), based on the previously received message (message 1 of FIG. 6) and the propagation delay estimates previously made (estimate delay_101 of FIG. 4 and estimate delay_102 of FIG. 5, for example).

In one embodiment, UE 100 encodes the propagation delay estimates or their sum into message 2. In another embodiment, UE 100 adds the propagation delay estimates to a clock value retrieved from message 1, and encodes the sum into message 2. In yet another embodiment, UE 100 transmits message 2 at a transmission time instant that depends on the reception time instant of message 1 and the propagation delay estimates. Message 2 may be transmitted at a time instant that is at a predetermined offset relative to the reception time instant of message 1, minus the sum of propagation delay estimates.

The message received by AP 102 can be similar to a forward message in a closed-loop synchronization scheme (as discussed above with reference to FIG. 8). As a response, AP 102 can generate a return message to be delivered to AP 101 via UE 100 in a similar manner to that already illustrated in FIGS. 6-7.

Based on the received return message, AP 101 can adjust its clock, using a synchronization algorithm. For example, AP 101 may determine the offset between its own clock and that of AP 102, and adjust its own clock by a fraction of the determined offset.

Additionally, certain embodiments can employ detection of movement of the nodes. Specifically certain embodiments can involve detecting device mobility and discarding the propagation delay estimate, if nodes have moved. Furthermore, certain embodiments can involve estimating movement at each node, accumulating the estimate of movement over time and transmitting the accumulated movement in a sync message

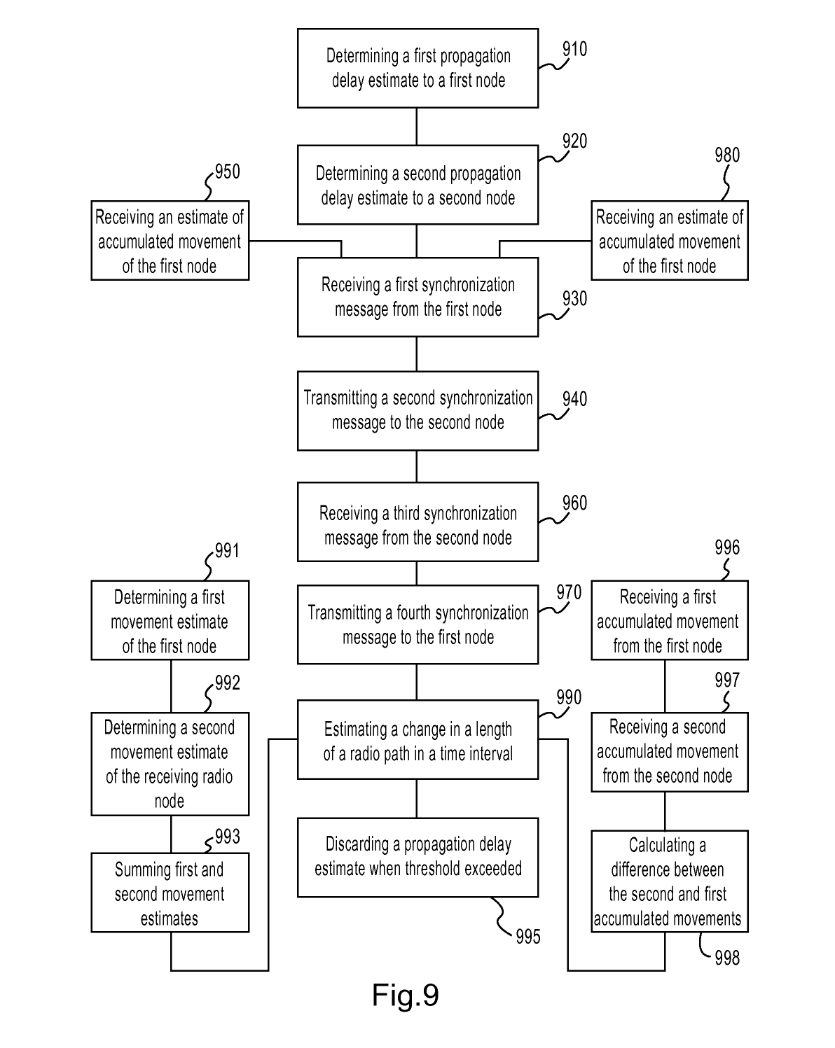

FIG. 9 illustrates a method according to an embodiment of the present invention. The method can be performed by, for example, a user equipment. The method can include determining 910 a first propagation delay estimate to a first node. The method can also include determining 920 a second propagation delay estimate to a second node. The method can further include receiving 930 a first synchronization message from the first node. The method can additionally include transmitting 940 a second synchronization message to the second node. The second synchronization message can depend on the first synchronization message, the first propagation delay estimate, and the second propagation delay estimate.

The method can further include receiving 950 an estimate of accumulated movement of the first node. The estimate can accompany the first synchronization message or can be separate from the first synchronization message.

The method can additionally include receiving 960 a third synchronization message from the second node and transmitting 970 a fourth synchronization message to the first node. The fourth synchronization message can depend on the third synchronization message, the first propagation delay estimate, and the second propagation delay estimate.

The method can additionally include receiving 980 an estimate of accumulated movement of the second node. The estimate can accompany the third synchronization message or can be separate from the third synchronization message.

The method can also include estimating 990 a change in a length of a radio path in a time interval and discarding 995 a propagation delay estimate when the estimated change in path length exceeds a threshold. The starting time of the timer interval can be the estimation of the propagation delay. The threshold can be set based on a variety of factors. However, in general the threshold can be set based on a tolerance for error with respect to path length or associated propagation delay. Thus, for example, a threshold can be set at 10% of the path length. Thus, if the path length is 10 m, then the threshold can be set to 1 m. This is simply one example of a threshold, other thresholds, such as 5% threshold or a 20% threshold are also possible.

The estimating 990 the change in the length of the radio path can include determining 991 a first movement estimate of the first radio node in a time interval, determining 992 a second movement estimate of a receiving radio node in a time interval, and summing 993 first and second movement estimates. The receiving radio node can be the radio node that performs the method. Alternatively, the estimating 990 the change in the length of the radio path can further include receiving 996 a first accumulated movement from the first radio node, receiving 997 a second accumulated movement from the first radio node, and calculating 998 a difference between the second accumulated movement and the first accumulated movement.

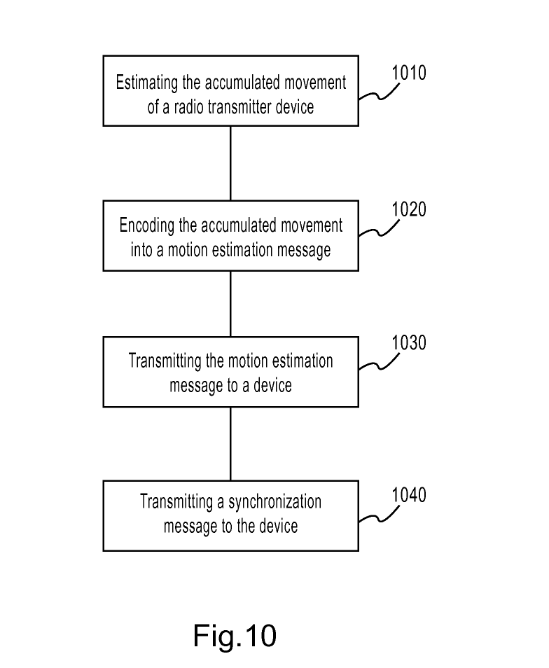

FIG. 10 illustrates a method according to embodiment of the present invention. The method can be performed by, for example, an access point. The method of FIG. 10 includes estimating 1010 the accumulated movement of a radio transmitter device. The method also includes encoding 1020 the accumulated movement into a motion estimation message. The method further includes transmitting 1030 the motion estimation message to a device.

The method can additionally involve transmitting 1040, included with the motion estimation message or separate from the motion estimation message, a synchronization message requesting synchronization via the device with a second radio transmitter device.

The methods illustrated in FIGS. 9 and 10 can be implemented various ways. For example, the methods can be implemented entirely with hardwired hardware components. However, in certain embodiments, a non-transitory computer-readable medium can be encoded with instructions that, when executed in hardware, perform a method such as the methods illustrated in FIGS. 9 and 10.

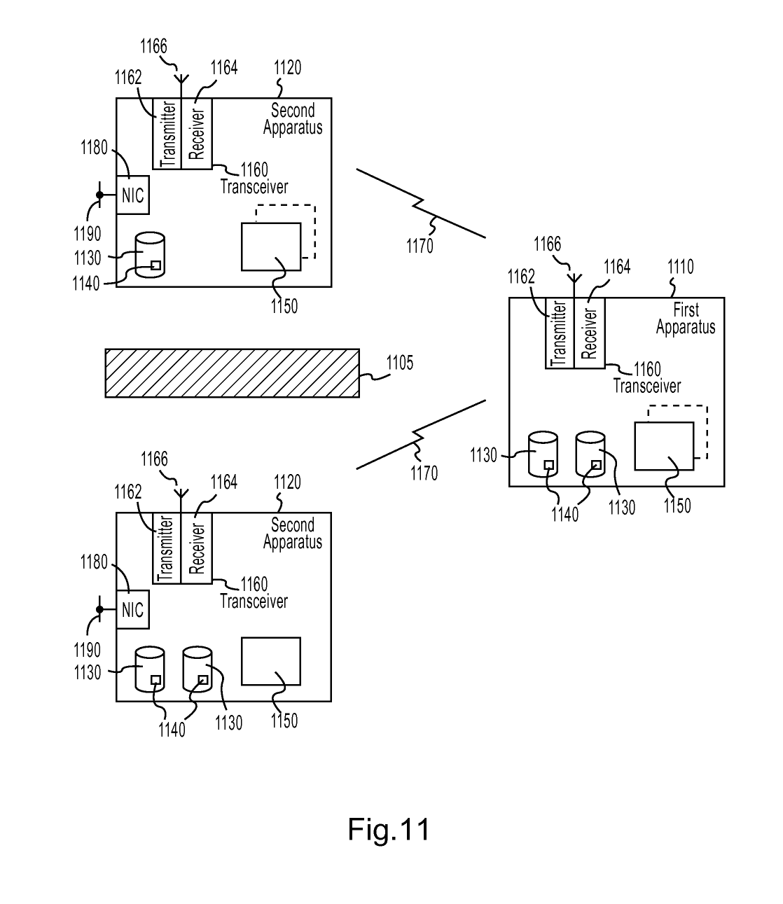

FIG. 11 illustrates a system according to an embodiment of the present invention. As illustrated in FIG. 11, the system can include a first apparatus 1110 and two second apparatuses 1120. The first apparatus 1110 may be a user equipment (UE) such as a mobile telephone or a personal computer. The second apparatuses 1120 can be access points (APs). Each of the first apparatus 1110 and second apparatuses 1120 can include at least one memory 1130 including computer program code 1140. Additionally, each of the first apparatus 1110 and second apparatuses 1120 can include at least one processor 1150. The memory 1130, computer program code 1140 and processor(s) 1150 can be configured to perform appropriate processes, such as the processes illustrated in FIG. 9 for the first apparatus 1110, or FIG. 10 for the second apparatuses 1120.

The memory 1130 may be any suitable memory, such as a hard drive, random access memory (RAM), or read-only memory (ROM). The computer program code 1140 can be, for example, compiled or interpreted computer instructions. The processor 1150 can be any suitable processing device, such as a controller, central processing unit (CPU), or application specific integrated circuit (ASIC). The processor 1150 can be on the same chip as the memory 1130, although this is not required.

FIG. 11 also illustrates that each of the first apparatus 1110 and second apparatuses 1120 can include a transceiver 1160. The transceiver can include a transmitter 1162 and a receiver 1164, which may be operably connected to an antenna 1166. Each antenna 1166 can communicate over a wireless link 1170.

The second apparatuses 1120 can further include a network interface card 1180 and Ethernet connection to one or more wired network 1190. An obstruction 1105, which can be either a physical object, a set of rules, or a physical reality of, for example, the propagation shape of the antennae 1166, can prevent direct communication of the second apparatuses 1120 with one another.

By the use of such systems and methods as have been discussed above, it may be possible to provide a synchronization accuracy better than the path delay between two nodes without continuous back-and-forth signaling. Such systems and methods could be useful involving cheap access points that need to be synchronized, as well as in environments, such as indoors, where GPS is not available.

Such three-node measurements, taking into account propagation delays, can result in improved accuracy compared with a system where propagation delays are neglected. In, for example, an OFDMA system this would be reflected as an overhead reduction, because a shorter cyclic prefix could be used. Additionally, the more specific part of utilizing the motion estimation when deciding on the validity of the propagation delay estimates can provide reduced signaling because the estimates are updated only if needed.

Accordingly, in certain embodiments of the present invention, propagation delays to a third node from two other nodes are determined in order to adjust the relative transmission phases of the two other nodes. Furthermore, such a system may be able to achieve synchronization with a compensation of propagation delay between two access points that can only communicate via a user equipment (UE).

Such accurate synchronization may be of use in radio systems that try to meet the performance standards of International Mobile Telecommunications (IMT)-Advanced (IMT-A) and beyond. Many modern algorithms such as successive interference cancellation may require very accurate synchronization, and consequently the systems and methods described above may be of use.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. For example, although much of the discussion above focused on a local-area radio system that may be configured to support high-rate coverage in small cells to LTE, other embodiments of the present invention are possible. In order to determine the metes and bounds of the invention, therefore, reference should be made to the appended claims.

1. A method, comprising:
determining a first propagation delay estimate to a first node;
determining a second propagation delay estimate to a second node;
receiving a first synchronization message from the first node; and
transmitting a second synchronization message to the second node wherein the second synchronization message depends on the first synchronization message, the first propagation delay estimate, and the second propagation delay estimate.

2. The method of claim 1, wherein the receiving the first synchronization message from the first node comprises receiving an estimate of accumulated movement of the first node.

3. The method of claim 1, further comprising:
receiving a third synchronization message from the second node; and
transmitting a fourth synchronization message to the first node, wherein the fourth synchronization message depends on the third synchronization message, the first propagation delay estimate, and the second propagation delay estimate.

4. The method of claim 3, wherein the receiving the third synchronization message from the second node comprises receiving an estimate of accumulated movement of the second node.

5. The method of claim 4, further comprising:
estimating a change in a length of a radio path in a time interval; and
discarding a propagation delay estimate when the estimated change in path length exceeds a threshold.

6. The method of claim 5, wherein the estimating the change comprises using the time interval starting with the estimation of the propagation delay.

7. The method of claim 5, wherein the estimating the change in the length of the radio path comprises
determining a first movement estimate of the first radio node in a time interval;
determining a second movement estimate of a receiving radio node in a time interval; and
summing first and second movement estimates.

8. The method of claim 5, wherein the estimating the change in the length of the radio path further comprises
receiving a first accumulated movement from the first radio node;
receiving a second accumulated movement from the first radio node; and
calculating a difference between the second accumulated movement and the first accumulated movement.

9. A method, comprising:
estimating the accumulated movement of a radio transmitter device;
encoding the accumulated movement into a motion estimation message; and
transmitting the motion estimation message to a device.

10. The method of claim 9, further comprising:
including, with the motion estimation message, a synchronization message requesting synchronization via the device with a second radio transmitter device.

11. An apparatus, comprising:
at least one memory including computer program code; and
at least one processor,
wherein the at least one memory and the computer program code are configured to, with the at least one processor, cause the apparatus at least to
determine a first propagation delay estimate to a first node;
determine a second propagation delay estimate to a second node;
process a received first synchronization message from the first node; and
transmit a second synchronization message to the second node wherein the second synchronization message depends on the first synchronization message, the first propagation delay estimate, and the second propagation delay estimate.

12. The apparatus of claim 11, wherein the at least one memory and the computer program code are also configured to, with the at least one processor, cause the apparatus at least to process an estimate of accumulated movement of the first node.

13. The apparatus of claim 11, wherein the at least one memory and the computer program code are further configured to, with the at least one processor, cause the apparatus at least to
process a received third synchronization message from the second node; and
transmit a fourth synchronization message to the first node, wherein the fourth synchronization message depends on the third synchronization message, the first propagation delay estimate, and the second propagation delay estimate.

14. The apparatus of claim 13, wherein the at least one memory and the computer program code are also configured to, with the at least one processor, cause the apparatus at least to process an estimate of accumulated movement of the second node.

15. The apparatus of claim 11, wherein the at least one memory and the computer program code are further configured to, with the at least one processor, cause the apparatus at least to
estimate a change in a length of a radio path in a time interval; and
discard a propagation delay estimate when the estimated change in path length exceeds a threshold.

16. The apparatus of claim 15, wherein the at least one memory and the computer program code are also configured to, with the at least one processor, cause the apparatus at least to use, as the time interval, a time interval starting with the estimation of the propagation delay.

17. The apparatus of claim 15, wherein the at least one memory and the computer program code are also configured to, with the at least one processor, cause the apparatus at least to
determine a first movement estimate of the first radio node in a time interval;
determine a second movement estimate of a receiving radio node in a time interval; and
sum the first movement estimate and second movement estimate to obtain an estimate of the change in the length of the radio path.

18. The apparatus of claim 15, wherein the at least one memory and the computer program code are also configured to, with the at least one processor, cause the apparatus at least to
process a received first accumulated movement from the first radio node;
process a received second accumulated movement from the first radio node; and
calculate a difference between the second accumulated movement and the first accumulated movement to obtain an estimate of the change in the length of the radio path.

19. An apparatus, comprising:
at least one memory including computer program code; and
at least one processor,
wherein the at least one memory and the computer program code are configured to, with the at least one processor, cause the apparatus at least to
estimate the accumulated movement of a radio transmitter device;
encode the accumulated movement into a motion estimation message; and
transmit the motion estimation message to a device.

20. The apparatus of claim 19, wherein the at least one memory and the computer program code are also configured to, with the at least one processor, cause the apparatus at least to include, with the motion estimation message, a synchronization message requesting synchronization via the device with a second radio transmitter device.

21. (canceled)
